(19) United States
(12) Patent Application Publication
(10) Pub. No.: US 2009/0117365 A1
(43) Pub. Date: May 7, 2009

(54) ELASTIC LAMINATE MADE WITH ABSORBENT FOAM

(75) Inventors: Mary F. Mallory, Alpharetta, GA (US); Fred Robert Radwanski, Stone Mountain, GA (US); Susan Elaine Shawver, Roswell, GA (US); David C. Strack, Canton, GA (US)

Correspondence Address: Christopher M. Goff (27839);ARMSTRONG TEASDALE LLP, ONE METROPOLITAN SQUARE, SUITE 2600, ST. LOUIS, MO, 63102, US

(73) Assignee: KIMBERLY-CLARK WORLDWIDE, INC., Neenah, WI (US)

(21) Appl. No.: 12/349,147

(22) Filed: Jan. 6, 2009

Related U.S. Application Data
(63) Continuation of application No. 11/319,003, filed on Dec. 27, 2005.

(51) Int. Cl. B32B 3/26

(52) U.S. Cl. 428/304.4

(57) ABSTRACT

An absorbent elastic laminate includes an elastic backing layer and a flexible thermoplastic absorbent foam layer. The flexible absorbent foam layer gathers when the laminate is in the relaxed state, permitting the elastic backing and the overall laminate to exhibit elastic stretch and recovery properties. The absorbent elastic laminate is useful in a wide variety of personal care absorbent articles, medical absorbent articles and absorbent wiping articles.

### CROSS-REFERENCE TO RELATED APPLICATION

This application is a continuation of U.S. patent application Ser. No. 11/319,003, filed Dec. 27, 2005, the entirety of which is hereby incorporated by reference.

### BACKGROUND OF THE INVENTION

This invention relates to an absorbent elastic laminate, and specifically to an elastic laminate including an absorbent foam layer and an elastic backing.

Personal care absorbent articles such as diapers, training pants, feminine hygiene articles and the like typically include a liquid permeable bodyside liner, a substantially liquid impermeable outer cover, and an absorbent core between them. In recent years, various efforts have been undertaken to make these articles stretchable or elastic, to achieve a fit that conforms more closely to the contours of a wearer's body. This trend began with the inclusion of elastic waistbands and leg bands, and has since progressed to the use of bodyside liner and outer cover materials that are elastic or stretchable in at least one direction, typically the lateral direction of the absorbent article.

However, absorbent cores are typically manufactured using 15 absorbent cellulose materials (which are inelastic) in combination with other ingredients that provide improved strength and absorbency. The use of absorbent cellulose materials and other inelastic materials causes conventional absorbent cores to be relatively inelastic and non-stretchable. Because the bodyside liner and outer cover are typically attached (directly or indirectly) to the absorbent core, the use of elastic or stretchable bodyside liners and outer covers may have limited impact in the absorbent region of the article.

There have been various efforts to increase the elasticity or stretchability of absorbent core, or to detach the absorbent core from the elastic or stretchable bodyside liner and/or outer cover. These efforts have had limited success. There is a need or desire for an elastic absorbent core material that can be stretched in tandem with an elastic bodyside liner and/or outer cover, which does not limit the stretchability of these other components.

### SUMMARY OF THE INVENTION

The present invention is directed to an absorbent elastic laminate including an elastic backing and an absorbent foam layer on one or both sides of the elastic backing. The elastic backing may be an elastic film, elastic woven or nonwoven web, array of spaced apart elastic strands, other elastic material, or combination thereof. The absorbent foam layer is an open-cell, flexible, thermoplastic foam which can be inelastic or elastic, and is suitably inelastic. The elastic backing and the absorbent foam layer are bonded together directly or indirectly. When the laminate is relaxed, gathers can form in the absorbent foam layer. The resulting elastic laminate has elastic properties in at least one direction.

The amount of gathering in the inelastic absorbent foam layer relates to the amount of stretching that the elastic laminate can undergo. When the elastic laminate is stretched, the gathers are reduced and/or flattened. If the absorbent foam layer is elastic, it need not be gathered and gathers (if present) will not necessarily limit the amount of stretching of the laminate. The absorbent foam layer may be combined with superabsorbent particles to increase its absorbency, and/or may be combined with other additives to impart various desired properties.

### BRIEF DESCRIPTION OF THE DRAWINGS

FIGS. 1A-1D illustrate the elastic absorbent laminate of the invention from the front and side edges.

FIG. 2 schematically illustrates a stretch-bonded laminating (“SBL”) process for making the absorbent elastic laminate of the invention.

FIG. 3 schematically illustrates a neck-bonded laminating (“NBL”) process for making the absorbent elastic laminate of the invention.

FIG. 4 schematically illustrates a vertical filament laminating (“VFL”) process, which is one embodiment of a SBL process.

FIG. 5 representatively shows a partially cutaway top view of a saturated capacity tester.

FIG. 6 representatively shows a side view of a saturated capacity tester.

FIG. 7 representatively shows a rear view of a saturated capacity tester.

FIGS. 8 and 9 representatively show a top view and a side view, respectively, of a test apparatus employed for the Fluid Intake Flux Test.

### DEFINITIONS

“Cell” refers to a cavity contained in foam. A cell is closed when the cell membrane surrounding the cavity or enclosed opening is not perforated and has all membranes intact. Cell connectivity occurs when at least one wall of the cell membrane surrounding the cavity has orifices or pores that connect to adjacent cells, such that an exchange of fluid is possible between adjacent cells.

“Compression” refers to the process or result of pressing by applying force on an object, thereby increasing the density of the object.

“Elastomer” or “elastic” refers to material having elastomeric or rubbery properties. Elastomeric materials, such as thermoplastic elastomers, are generally capable of recovering their shape after deformation when the deforming force is removed. Specifically, as used herein, elastomeric is meant to be that property of any material which upon application of an elongating force, permits that material to be stretchable to a stretched length which is at least about 50 percent greater than its relaxed length, and that will cause the material to recover at least 50 percent of its elongation upon release of the stretching elongating force. A hypothetical example which would satisfy this definition of an elastomeric material in the X-Y planar dimensions would be a one (1) inch (2.54 cm) sample of a material which is elongatable to at least 1.50 inches (3.80 cm) and which, upon removal of the stretching force, will recover to a length of not more than 1.25 inches (3.18 cm). Many elastomeric materials may be stretched by much more than 50 percent of their relaxed length, and many of these will recover to substantially their original relaxed length upon release of the stretching, elongating force.

“Flexible” refers to a material that can be easily bent or gathered. Flexible absorbent foams are those which can be gathered due to the retractive force of an adjacent elastic layer.

“Gathered” refers to a material or layer having three-dimensional topography characterized by a pattern of wrinkles, striations, rugosities, waves, pleats, or the like.

“Open-cell” refers to any cell that has at least one broken or missing 30 membrane or a hole in a membrane. “Open-cell foam” refers to a foam having at least 50% open cells as determined by ASTM D2856.

“Percent stretch” refers to the ratio determined by measuring the increase in the stretched dimension and dividing that value by the original dimension; i.e., (increase in stretched dimension/original dimension)×100.

“Set” refers to retained elongation in a material sample following the elongation and recovery, i.e., after the material has been stretched and allowed to relax during a Cycle Test as described below.

“Percent set” is the measure of the amount of the material stretched from its original length after being cycled (the immediate deformation following the Cycle Test described below). The percent set is where the retraction curve of a cycle crosses the elongation axis. The remaining strain after removal of the applied stress is measured as the percent set.

“Load loss” value is determined by first elongating the sample to a defined elongation in a particular direction (such as the CD) of a given percentage (such as 70, or 100 percent as indicated) and then allowing the sample to retract to an amount where the amount of resistance is zero. The cycle is repeated a second time and the load loss is calculated at a given elongation, such as the 50 percent elongation. Unless otherwise indicated, the value was read at the 50% elongation level (on a 100 percent elongation test) and then used in the calculation. For the purposes of this application, the load loss was calculated as follows

$$\frac{[ \begin{matrix}Cycle 1 extension tension ( at 50 \% elongation ) - \\ Cycle 2 retraction tension ( at 50 \% elongation )\end{matrix} ]}{Cycle 1 extension tension ( at 50 \% elongation )} \times 100$$

For the results reflected in this application, the defined elongation was 100 percent. The actual test method for determining load loss values is described below.

“Recover,” “recovery” and “recovered” refer to a contraction (retraction) of a stretched material upon termination of a stretching force following stretching of the material by application of the stretching force. For example, if a material having a relaxed, unstretched length of 1 inch (2.5 cm) is elongated fifty percent by stretching to a length of 1.5 inches (3.75 cm), the material would be elongated 50 percent and would have a stretched length that is 150 percent of its relaxed length or stretched 1.5× (times). If this exemplary stretched material contracted, that is recovered to a length of 1.1 inches (2.75 cm) after release of the stretching force, the material would have recovered 80 percent of its 0.5 inch (1.25 cm) elongation. Percent recovery may be expressed using the Cycle Test as [(maximum stretch length-final sample length)/(maximum length-initial sample length)]×100.

“Plasticizing agent” refers to a chemical agent that can be added to a rigid polymer to add flexibility to rigid polymers. Plasticizing agents typically lower the glass transition temperature.

“Polymer” generally includes but is not limited to, homopolymers, copolymers, including block, graft, random and alternating copolymers, terpolymers, etc., and blends and modifications thereof. Furthermore, unless otherwise specifically limited, the term “polymer” shall include all possible molecular geometrical configurations of the material. These configurations include, but are not limited to isotactic, syndiotactic, and atactic symmetries.

“Surfactant” is a compound, such as detergents and wetting agents, that reduces the surface tension of fluids.

“Thermoplastic” is meant to describe a material that softens and/or flows when exposed to heat and which substantially returns to its original hardened condition when cooled to room temperature.

“Absorbent article” includes, but is not limited to, personal care absorbent articles, medical absorbent articles, absorbent wiping articles, as well as non-personal care absorbent articles including filters, masks, packaging absorbents, trash bags, stain removers, topical compositions, laundry soillink absorbers, detergent agglomerators, lipophilic fluid separators, mitts, gloves, cleaning devices, and the like.

“Personal care absorbent article” includes, but is not limited to, absorbent articles such as disposable diapers, baby wipes, training pants, child-care pants, and other disposable garments; feminine-care products including sanitary napkins, wipes, menstrual pads, panty liners, panty shields, interlabials, tampons, and tampon applicators; adult-care products including wipes, pads, containers, incontinence products, and urinary shields; mitts and gloves; and the like.

“Medical absorbent article” includes a variety of professional and consumer health-care products including, but not limited to, products for applying hot or cold therapy, hospital gowns, surgical drapes, bandages, wound dressings, covers, containers, filters, disposable garments and bed pads, medical absorbent garments, gowns, underpads, wipes, mitts, gloves, and the like.

“Absorbent wiping article” includes facial tissue, towels such as kitchen towels, disposable cutting sheets, away-from-home towels and wipers, wet-wipes, mitts, gloves, sponges, washcloths, bath tissue, and the like.

### DETAILED DESCRIPTION OF THE INVENTION

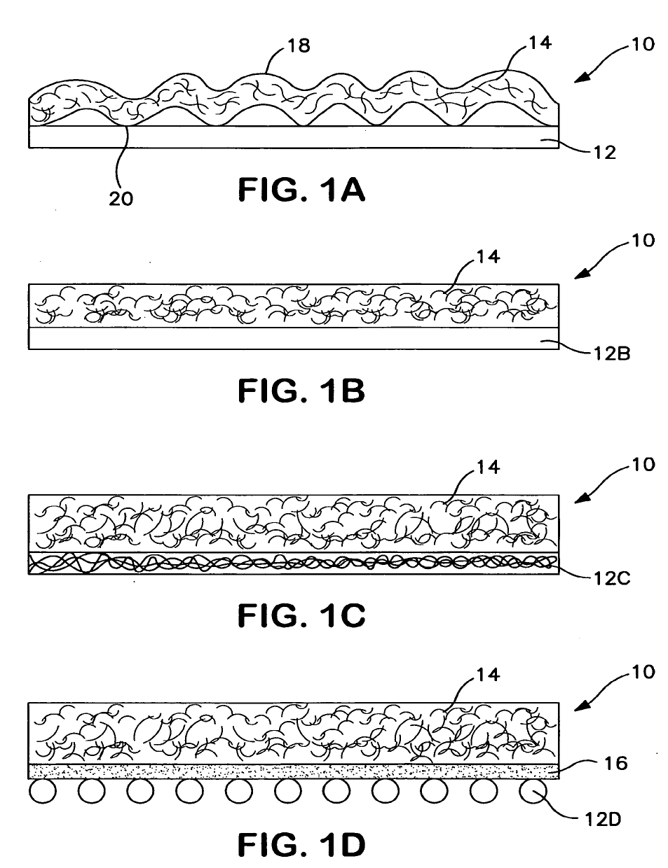

FIGS. 1A through 1D represent front and side views of the elastic absorbent laminate of the invention. If the laminate 10 is made using a SBL process (described below), then FIG. 1A represents a generic side edge view and FIGS. 1B, 1C and 1D represent front edge views of different embodiments of the elastic absorbent laminate 10. If the laminate 10 is made using a NBL process (described below), then FIG. 1A represents a generic front edge view and FIGS. 1B, 1C and 1D represent side edge views of different embodiments of the elastic absorbent laminate 10.

The elastic absorbent laminate 10 of the invention includes an elastic backing 12 and a flexible absorbent open-cell foam layer 14 on one or both sides of the backing 12. The elastic backing 12 may be an elastic film layer 128, an elastic woven or nonwoven web layer 12C, an array of substantially parallel spaced-apart elastic strands 12D, another elastic material, or a combination of the foregoing. Additional woven or nonwoven webs can be bonded to or made part of the elastic absorbent laminate. When the laminate 10 is in a relaxed state, the foam layer 14 is gathered. The gathers 18 may be in the form of any three-dimensional topography characterized by a repeating pattern of wrinkles, striations, rugosities, waves, pleats, or the like.

The elastic backing 12 and flexible absorbent open-cell foam layer 14 may be directly or indirectly bonded together. “Direct bonding” refers to embodiments where the layers 12 and 14 are bonded in direct contact with each other, such as by thermal or ultrasonic bonding. “Indirect bonding” refers to embodiments where the layers 12 and 14 are bonded together in the same laminate 10, but do not directly contact each other due to the presence of an intervening adhesive or pressure sensitive layer 16 (FIG. 1D) or another intervening layer. Any suitable bonding technique may be employed including calendar bonding, stitch-bonding, mechanical or hydraulic needling, or the like. The invention is not circumvented by the presence of intervening layers, so long as the elastic properties of the laminate 10 are maintained.

The bonding between layers 12 and 14 may occur at a plurality of spaced apart locations, or may be substantially continuous. If the bonding occurs at spaced apart locations, such as locations 20 in FIG. 1A, then the elastic backing 12 and absorbent foam layer 14 will be separated at locations between the bonds, corresponding to the locations of gathers 18, when the laminate 10 is in a relaxed state. If the bonding is substantially continuous (e.g., due to smooth calender bonding), then the elastic backing 12 may gather to some extent along with the absorbent foam layer 14 when the laminate 10 is in a relaxed state.

The gathers 18 are formed in a SBL process (described below) due to the fact that the elastic backing 12 is in a stretched state when the layers 12 and 14 are bonded together. Subsequent relaxation of the laminate forms the gathers. The gathers 18 are formed in a NBL process (described below) by neck stretching the absorbent foam layer 14 in a first (e.g. machine) direction to cause narrowing and gathering of the layer 14 in a second (e.g. cross) direction perpendicular to the first direction, before the layers 12 and 14 are bonded together. The magnitude and frequency of the gathers 18 typically determine the elastic stretchability of the laminate 10 in at least one direction because the gathers reduce or flatten out when the laminate 10 is stretched. For instance, the amount or percent of possible extension of the laminate 10 approximately corresponds to the difference between the surface pathlength of the absorbent foam layer 14 and the straight-line (aggregate) length of the laminate 10, when the laminate 10 is relaxed. The absorbent elastic laminate 10 should have an elastic extensibility of at least about 50% in at least one direction, suitably at least about 75%, or at least about 100%, or at least about 200%, and up to about 500% or more. In the NBL process, the elastic backing can be a film.

The elastic backing 12 may be fanned from a variety of elastic polymers, and blends including elastic polymers. Suitable elastic polymers include without limitation a) styrenic block copolymer elastomers, such as diblock copolymers including styrene-isoprene and styrene-butadiene, and triblock or tetrablock copolymers including styrene-isoprene-styrene (SIS), styrene-butadiene-styrene (SBS), styrene-isoprene-butadiene-styrene (SIBS), styrene-(ethylene-butylene)-styrene (SEBS), styrene-(ethylene propylene)-styrene (SEPS), and combinations thereof. Other suitable elastic polymers are b) polyolefin-based random copolymer elastomers including ethylene-propylene rubber (EPR), ethylene-propylene-diene monomer (EPDM), and elastomeric single-site catalyzed ethylene-alpha olefin copolymers; c) polyolefin-based block copolymer elastomers including hydrogenated butadiene-isoprene-butadiene block copolymers; d) thermoplastic polyether ester elastomers; e) ionomeric thermoplastic elastomers; f) polyamide thermoplastic elastomers; g) thermoplastic polyurethanes; h) propylene-based elastic copolymers; and i) combinations thereof.

The flexible absorbent open-cell foam layer should have an open-cell content of at least 50% measured using ASTM D2856. Suitably, the open-cell content should be at least about 55%, or at least about 65%, or at least about 75%, and up to about 95%. The high open-cell content improves the absorbent properties of the foam layer. However, a small amount of closed cells (e.g. up to about 5%, or up to about 10%) helps provide the foam layer with softness, resiliency, and bulk.

The flexible absorbent foam layer is suitably a thermoplastic foam is layer, and may include a thermoplastic base resin, a surfactant, and at least one of a plasticizing agent and a thermoplastic elastomer. Suitable compositions for the flexible absorbent foam layer are described in U.S. Patent Application Publication 2005/0124709 to Krueger et al., the disclosure of which is incorporated by reference. The functions of the various foam composition ingredients are described in elaborate detail in the Krueger et al. publication, and need not be repeated here.

In one embodiment, the flexible absorbent foam layer includes about 45 to about 90% by weight of the thermoplastic base resin, about 10 to about 55% by weight of the plasticizing agent, and about 0.05 to about 10% by weight of the surfactant. In another embodiment, the flexible absorbent foam layer includes about 45 to about 90% by weight of the thermoplastic base resin, about 10 to about 55% by weight of the thermoplastic elastomer, and about 0.05 to about 10% by weight of the surfactant. In another embodiment, the plasticizer and thermoplastic elastomer are both present in a combined amount of about 10 to about 55% by weight. Also, the thermoplastic elastomer may serve as a plasticizer, rendering the terminology indistinct.

Suitably, the flexible absorbent foam layer may include about 50 to about 85% by weight, or about 55 to about 80% by weight, of the thermoplastic base resin. The flexible absorbent foam layer may include about 10 to about 50% by weight, or about 15 to about 45% by weight, of either a) the plasticizer, b) the thermoplastic elastomer, or c) the plasticizer and thermoplastic elastomer combined. The flexible absorbent foam layer may include about 0.1 to about 8% by weight, or about 0.5 to about 5% by weight, of the surfactant.

Suitable thermoplastic base resins include without limitation polystyrene, styrene copolymers, other alkenyl aromatic polymers, polyolefins, polyesters and combinations thereof. The base resin can be inelastic (i.e. does not exhibit the elastic stretch and recovery properties defined above for elastic materials). Polystyrenes and inelastic styrene copolymers, as well as other inelastic alkenyl aromatic polymers are suitable. Suitable polyolefins include inelastic homopolymers and copolymers of polyethylene, polypropylene, polybutylene and the like. Suitable polyesters include polyalkylene terephthalates, such as polyethylene terephthalate and polybutylene terephthalate. Biodegradable thermoplastic polymers, including polylactic acid and starches, can also be employed.

Suitable plasticizing agents include without limitation low molecular weight citrates, phthalates, stearates, esters, fats, and oils. Glycerol fatty acids, such as glycerol monostearate and the like, are suitable. Petroleum-based oils, fatty acids, and esters are useful. Specific examples include low molecular weight polyethylene, low molecular weight ethylene vinyl acetate, mineral oil, palm oil, waxes, esters based on alcohols and organic acids, naphthalene oil, paraffin oil, and combinations thereof. Other specific examples include acetal tributyl citrate, acetal triethyl citrate, p-tert-butylphenylsalycitate, butyl stearate, butylphthalyl butyl glycolate, dibutyl sebacate, di-(2-ethylhexyl) phthalate, diethyl phthalate, diisobutyl adipate, diisooctyl phthalate, diphenyl-2-ethyhexyl phosphate, epoxidized soybean oil, ethylphthalyl ethyl glycolate, glycerol monooleate, monoisopropyl citrate, mono-, di-, and tristearyl citrate, triacetin (glycerol triacetate), triethyl citrate, 3-(2-xenoyl)-1,2-epoxypropane, and combinations thereof.

Suitable thermoplastic elastomers include without limitation a) styrenic block copolymer elastomers, such as dibiock copolymers including styrene-isoprene and styrene-butadiene, and triblock or tetrablock copolymers, including styrene-isoprene-styrene (SIS), styrene-butadiene-styrene (SBS), styrene-isoprene-butadiene-styrene (SIBS), styrene-(ethylene-butylene)-styrene (SEBS), styrene-(ethylene-propylene)-styrene (SEPS), and combinations thereof. Other suitable elastic polymers are b) polyolefin-based random copolymer elastomers including ethylene-propylene rubber (EPR), ethylene-propylene-diene monomer (EPDM), and elastomeric single-site catalyzed ethylene-alpha olefin copolymers; c) polyolefin-based block copolymer elastomers including hydrogenated butadiene-isoprene-butadiene block copolymers; d) thermoplastic polyether ester elastomers; e) ionomeric thermoplastic elastomers; f) polyamide thermoplastic elastomers; g) thermoplastic polyurethanes; and h) combinations thereof.

Styrenic block copolymer elastomers are particularly suitable. These elastomers are available from Kraton Polymers LLC of Belpre, Ohio under the trade name KRATON®; from Dexco, a division of ExxonMobil Chemical Co. in Houston, Tex. under the trade name VECTOR®; or from Kuraray America, Inc. of New York, N.Y. under the trade name SEPTON®. Particularly suitable Styrenic block copolymer elastomers have a high diblock content of about 50% to about 80% by weight, and a high molecular weight.

Thermoplastic polyether ester elastomers, ionomeric thermoplastic elastomers, and thermoplastic elastomeric polyurethanes are available from E.I. DuPont De Nemours in Wilmington, Del. Thermoplastic elastic polyamides, including polyether block amides, are available from Atofina Chemicals, Inc. of Philadelphia, Pa. under the trade name PEBAX®. Thermoplastic polyesters are available from E.I. DuPont De Nemours & Co. under the trade name HYTREL®; and from DSM Engineering Plastics of Evansville, Ind., under the trade name ARNITEL®. Elastomeric single-site catalyzed polyolefins, including ethylene-alpha olefin copolymers having a density less than 0.89 grams/cm3 are available from Dow Chemical Co. of Midland, Mich. under the trade name AFFINITY®. Polyethylene elastomers available from ExxonMobil Chemical Co. under the trade name EXACT™ can also be used.

Examples of suitable surfactants include cationic, anionic, 25 amphoteric, and nonionic surfactants. Anionic surfactants include alkylsulfonates. Examples of commercially available surfactants include I-IOSTASTAT® HS-l, available from Clariant Corporation in Winchester, Va., U.S.A.; Cognis EMEREST® 2650, Cognis EMEREST®2648, and Cognis EMEREST® 3712, each available from Cognis Corporation in Cincinnati, Ohio, U.S.A.; and Dow Coming 193, available from Dow Chemical Company in Midland, Mich., U.S.A. Alkyl sulfonates are quite effective; however, use of this class of surfactants in certain applications may be limited because of product safety. Some combinations offer unexpected benefits where the alkyl sulfonate is added at a substantially lower level in conjunction with another surfactant to yield good foaming and wettability. In one embodiment, for example, the surfactant can be added to the foam polymer formula in a gaseous phase, such as through the use of a blowing agent such as supercritical carbon dioxide. One benefit of using a gaseous surfactant is that the surfactant can fully penetrate and be incorporated into the polymer matrix, which can improve substantivity and thereby reduce surfactant fugitivity to enhance the foam's permanent wettability.

Other additives can be included in the foam polymer formula to enhance the properties of the resulting foam. For example, a nucleant can be added to improve foam gas bubble formation in the foam polymer formula. Examples of suitable nucleants include talc, magnesium carbonate, nanoclay, silica, calcium carbonate, modified nucleant complexes, and combinations thereof. An example of a commercially available nucleant is a nanoclay available under the trade name CLOISITE®20A, from Southern Clay Products, Inc. in Gonzales, Tex., U.S.A. The nucleant can be added to the foam polymer formula in an amount between about 0.1% and about 5% by weight of the foam polymer formula.

A blowing agent can be added to the foam polymer formula to aid in the foaming process. Blowing agents can be compounds that decompose at extrusion temperatures to release large volumes of gas, volatile liquids such as refrigerants and hydrocarbons, or ambient gases such as nitrogen and carbon dioxide, or water, or combinations thereof. A blowing agent can be added to the foam polymer formula in an amount between about 1% and about 10% by weight of the foam polymer formula.

The flexible absorbent foam layer 14 can be prepared using any of the techniques described in the foregoing U.S. Patent Application Publication 2005/0124709. Other techniques for making open-celled thermoplastic foam can also be employed.

In one embodiment, the flexible absorbent foam layer is combined with a superabsorbent material, such as superabsorbent particles or fibers, to enhance its absorbent properties. The term “superabsorbent” refers to water-swellable organic and inorganic materials that are capable of absorbing at least 15 times their own weight in an aqueous solution of 0.9% by weight sodium chloride under the most favorable conditions. Suitable superabsorbent polymers include without limitation alkali metal and ammonium salts of poly(acrylic acid) and poly(methacrylic acid), poly(acrylamides), hydrolyzed maleic anhydride copolymers with vinyl ethers, hydrolyzed maleic anhydride copolymers with alpha-olefins, polyacrylates, polymers and copolymers of vinyl sulfonic acid, and combinations thereof. Further superabsorbent materials include natural and modified natural polymers, such as hydrolyzed acrylonitrile-grafted starch, partially hydrolyzed acrylic acid grafted starch, carboxymethyl cellulose, multicomponent superabsorbent polymers, and combinations thereof.

The amount of superabsorbent material incorporated into the flexible absorbent foam layer depends on the level of absorbency required. For instance, the amount of superabsorbent material may vary from about 1 to about 100 parts by weight of superabsorbent material per 100 parts by weight of the flexible absorbent foam composition as described above. At levels above 100 parts by weight of superabsorbent polymer per 100 parts by weight of flexible absorbent foam composition, the superabsorbent polymer may inhibit the ability of the flexible absorbent foam layer 14 to is flex and gather, thus interfering with the elastic properties of the laminate 10. More specifically, the amount of superabsorbent material may range from about 5 to about 75 parts by weight, or about 10 to about 50 parts by weight of superabsorbent material per 100 parts by weight of flexible absorbent foam composition. The superabsorbent material may be incorporated directly into the flexible absorbent foam composition, or applied to a 20 surface of the flexible absorbent foam layer 14. Other absorbent materials, such as cellulose fibers, and other additives may also be incorporated into the flexible absorbent foam layer 14.

In one embodiment of the invention, the flexible absorbent foam layer 14 can be mechanically stretched to achieve a degree of permanent elongation. If the stretching of layer 14 occurs before the laminate 10 is formed, the flexible absorbent foam layer 14 will be made thinner, more flexible, and more absorbent (due in part to the consequent increase in open-cell size and cell elongation). If the entire laminate 10 is mechanically stretched to cause permanent elongation of the flexible absorbent foam layer 14, then the elastic stretch and recovery of the laminate 10 will be increased during subsequent use, due to the fact that the laminate 10 and elastic backing 12 may then be stretched by a greater amount without being hindered by the flexible absorbent foam layer 14.

The flexible absorbent foam layer 14 has a wide variety of properties that render it suitable for use in personal care absorbent articles, medical absorbent articles, absorbent wiping articles, etc. as defined above. For instance, the flexible absorbent foam layer 14 remains suitably absorbent after repeated insults of the elastic absorbent laminate 10. The elastic absorbent laminate 10 (due to the flexible absorbent foam layer 14) has a fluid intake flux of about 0.15 ml/sec/cm² or greater upon a first insult, about 0.15 ml/sec/cm² or greater upon a second insult, and about 0.15 ml/sec/cm² or greater upon a third insult, measured using the Fluid Intake Flux Test described herein. The surface permanence of the foam remains intact such that about 15% or less of the surfactant is washed off of the foam layer 14 after the laminate 10 is soaked in water for 24 hours, using the Surfactant Permanence Test described below. The supernatant in the Surfactant Permanence Test maintains a surface tension greater than about 40 dynes/cm, or greater than about 50 dynes/cm, or greater than about 60 dynes/cm.

The absorbent elastic laminate 10 (due to the flexible absorbent foam 15 layer 14) has a saturated capacity of at least about 1.0 grams of 0.9% aqueous saline solution per grain of absorbent foam (“gig”), suitably at least about 7.0 grams/gram, or at least about 10 gig, using the Saturated Capacity Test described below. When superabsorbent material is added to the flexible absorbent foam layer 14, the saturated capacity may be increased to at least about 15 gig, or at least about 25 gig, or at least about 50 gig, up to about 100 gig.

The absorbent elastic laminate 10 may have a percent set of less than about 50%, or less than about 35%, or less than about 25% measured using the Cycle Test described below. The absorbent elastic laminate 10 may have a percent load loss at 50% strain of about 40 to about 90, suitably about 55 to about 65, measured using the Cycle Test. The absorbent elastic laminate 10 may have an extension tension at 50% strain, in grains force per 2 inch (5.08 cm) width, of about 500 to about 2500 grams, suitably about 700 to about 1500 grams, which is a desirable range for many wearable absorbent article applications. The absorbent elastic laminate 10 may have a retraction tension at 50% strain, measured in grams force, of about 50 to about 500 grams, suitably about 100 to about 300 grams. The extension and retraction tensions are measured using the Cycle Test.

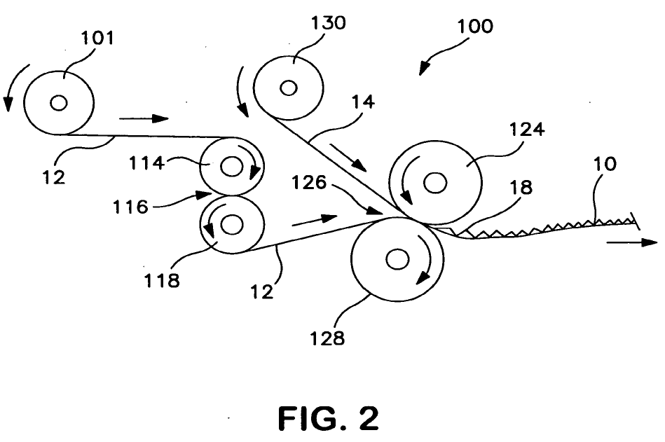

FIGS. 2-4 illustrate alternative techniques useful for making the elastic absorbent laminate 10 of the invention, FIG. 2 illustrates a stretch-bonded laminating process 100 for making a stretch-bonded laminate (“SBL”). Flexible absorbent foam layer 14 is unwound from a storage roll 130 or, alternatively, may be processed directly from an extrusion apparatus (not shown). The flexible absorbent foam layer 14 is directed to a nip 126 defined by nip rolls 124 and 128, where it is combined with elastic backing layer 12 to make the elastic absorbent laminate 10.

Elastic backing 12, such as an array of elastic strands, or an elastic film, woven or nonwoven web, or serim, is unwound from storage roll 101 or processed directly from an extrusion apparatus (not shown). The elastic backing 12 then passes through a first nip 116 defined by nip rolls 114 and 118, and second nip 126 defined by rolls 124 and 128. The nip rolls 124 and 128 counterrotate at a faster surface velocity than the nip rolls 114 and 118, causing stretching of the elastic backing 12 between the first nip 116 and the second nip 126. The elastic backing 12 can be stretched by at least 50% of its initial length, or at least 75%, or at least 100%, or at least 200%, up to about 500% or more, before it is combined with flexible absorbent foam layer 14 in the second nip 126. After passing through the nip 126, the elastic backing 12 and resulting laminate 10 are permitted to relax, forming gathers 18 in the flexible absorbent foam layer 14.

The layers 12 and 14 may be thermally bonded by heating one or both of the rolls 124 and 128 in the second nip. Alternatively, the layers 12 and 14 may be adhesively bonded by applying an adhesive to an adjoining surface of either layer (12 or 14) before the layers are combined. Other suitable bonding techniques may be employed, including stitch-bonding, hydraulic entangling, ultrasonic bonding, or mechanical needling. Suitably, the layers 12 and 14 are bonded at spaced-apart locations, such as by imparting a thermal or adhesive bonding pattern to either nip roll (124 or 128), or by applying an adhesive at spaced apart locations. Pressure-sensitive adhesives can also be employed.

Adhesive webs can also be used. By bonding the layers 12 and 14 using a controlled pattern, the size and frequency of gathers 18 can be controlled. If the layers 12 and 14 are continuously bonded, the gathers 18 will form, but will have a more random size and frequency. Also, the entire laminate 10 may gather if there is continuous bonding between the layers. The resulting absorbent elastic laminate 10 is elastically stretchable in the machine direction (parallel to the direction of travel).

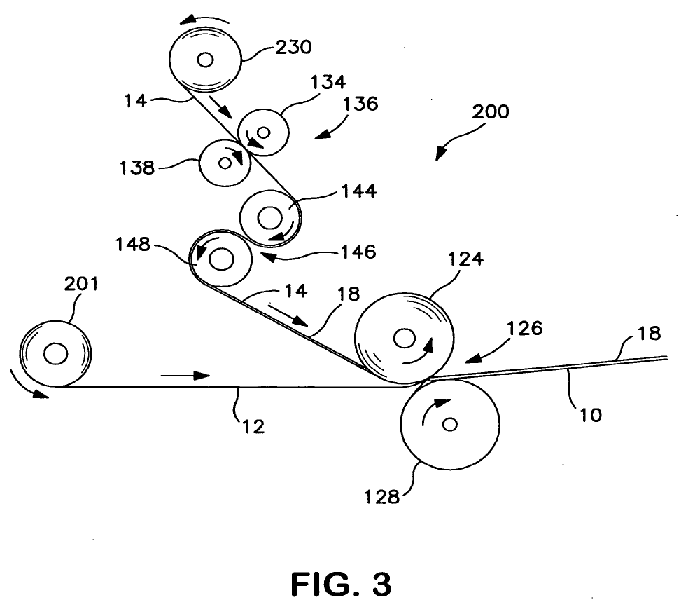

FIG. 3 illustrates a neck-bonded laminating process 200 for making a neck-bonded laminate (“NBL”). Flexible absorbent foam layer 14 is unwound from a storage roll 230 or, alternatively, may be processed directly from an extrusion apparatus (not shown). The flexible absorbent foam layer is directed through a first nip 136 defined by counterrotating nip rolls 134 and 138 which turn at a first surface velocity, then a second nip 146 defined by co-rotating S-wrap nip rolls 144 and 148 which turn at a second higher surface velocity. The second surface velocity may be about 1.1 to about 1.7 times the first surface velocity, and is suitably about 1.2 to about 1.5 times the first surface velocity. Because the flexible absorbent foam layer 14 is generally inelastic, the primary effect of this stretching operation is to cause the layer 14 to neck (narrow) in the cross direction (perpendicular to the plane of FIG. 3). This neck stretching causes formation of gathers 18 in the flexible absorbent foam layer 14 before it contacts the elastic backing 12. Unlike the SBL process described above, the gathers 18 resulting from neck stretching are generally oriented in the machine direction (direction of travel) of the elastic absorbent foam layer 14 and the gathering pattern is visible from a cross-directional perspective.

The elastic backing 12, which is typically a flint, is unwound from 15 storage roll 201 or processed directly from an extrusion apparatus (not shown). The elastic backing 12 need not be stretched and may proceed directly to the nip 126 defined by nip rolls 124 and 128, where it is combined with the neck-stretched flexible absorbent foam layer 14 to form the laminate 10. The absorbent elastic laminate 10 is extensible in the cross-direction (perpendicular to the plane of FIG. 3). The layers 12 and 14 may be bonded together using thermal bonding, adhesive bonding, or another suitable technique.

In an alternative embodiment, the elastic backing layer 12 in FIG. 3 (such as an elastic film, nonwoven or woven web, scrim, or strand array) can be pre-stretched using a stretching apparatus similar to the one illustrated in FIG. 2, prior to being combined with the necked absorbent foam layer 14. The resulting laminate 10 would be in the form of a neck-stretch-bonded laminate (“NSBL”), would have gathers 18 in both the machine and cross directions, and would be elastically stretchable in both (mutually perpendicular) directions.

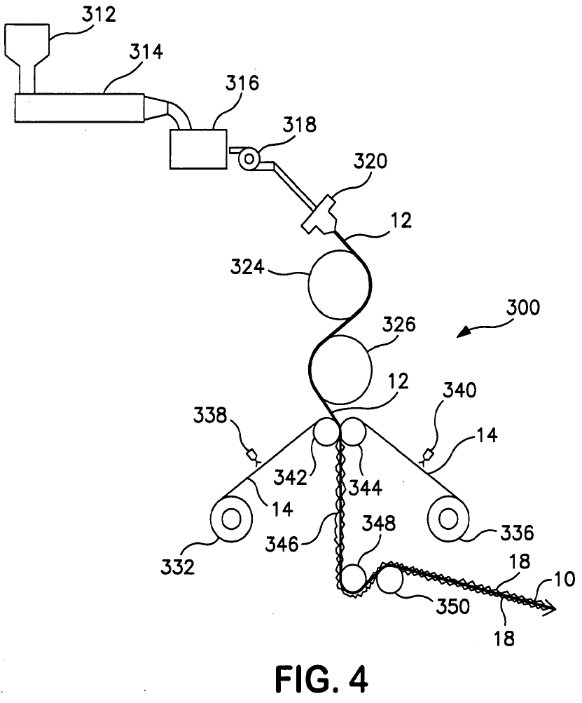

FIG. 4 illustrates a vertical filament laminating process for making a vertical filament laminate (“VEt”). An elastic polymer mixture is added via feeder 312 to an extrusion mixer 314, which melt blends the ingredients and feeds the blend through a feedblock 316 to a spin pump 318. The spin pump 318 forms the elastic polymer blend using die 320 to form individual filament streams as an array 12 of substantially parallel continuous filaments defining an elastic backing, using a suitable die geometry, die temperature, and die pressure. The elastic filaments in the filament array 12 are pulled around chill rolls 324 and 326, and are cooled. The elastic filaments in the filament array 12 are stretched during this process as explained below.

A first flexible absorbent foam layer 14 is unwound from a storage roll 332 or supplied from an extrusion apparatus. A second flexible absorbent foam layer 14 (or, alternatively, a layer of different material) is unwound from storage roll 336 or supplied from an extrusion apparatus. The flexible absorbent foam layers 14 are each sprayed with a melt spray adhesive using adhesive applicators 338 and 340. A suitable adhesive is Findley brand H2096, available from Ato-Findley Adhesives of Milwaukee, Wis. The adhesive may be applied at a basis weight of about 1-2 grams/rn2, using a spray die temperature of about 175-205° C.

The flexible absorbent foam layers 14 are combined with the elastic filament array 12 at a juncture between two counterrotating nip rolls 342 and 344. One of 15 the nip rolls may be plasma coated, and the other may have a rubber surface. The nip rolls 342 and 344 may exert a suitable bonding pressure.

The nip rollers 342 and 344 turn at surface speeds about 1.5 to 6 times as fast as the surface speeds of chill rolls 324 and 326, causing significant elongation of the elastic filament array 12 in the vicinity of the chill rolls, and in a stretching zone located between the chill rolls and the nip rolls. The nip rolls 342 and 344 do not turn at surface speeds significantly faster than the unwind rolls 332 and 336, thus, there is little or no stretching of the flexible absorbent foam layers 14. Accordingly, when the filament array 12 is sandwiched between the flexible absorbent foam layers 14 and bonded, the elastic filaments are substantially stretched and the flexible absorbent foam layers are substantially unstretched.

The resulting absorbent elastic laminate 10 is passed around S-rolls 348 and 350 and conveyed to storage or use. When the absorbent elastic laminate 10 is relaxed (untensioned), the elastic filament array 12 recovers, causing ruffles or gathers 18 in both flexible absorbent foam layers 14. The relaxed laminate 10 exhibits elastic stretching and recovery properties in the direction parallel to the lengths of the continuous elastic filaments.

The absorbent elastic laminate 10 may be used in a wide variety of absorbent articles as defined above. When used in a personal care absorbent article, the absorbent elastic laminate 10 may include superabsorbent material and may be employed as an absorbent core between a liquid permeable bodyside liner and a substantially liquid impermeable outer cover. When used in a medical absorbent article, the absorbent elastic laminate 10 provides the article with a soft, comfortable feel as well as providing good absorbent properties. When used as an absorbent wiping article, the absorbent elastic laminate 10 may include a flexible absorbent foam layer 14 on one or both sides of the article, depending on the end use application.

### EXAMPLES

A commercial flexible absorbent open-celled foam sold under the trade name VOLTEK® Minicell Foam by Voltek Division of Sekisui America Corp. located in Lawrence, Mass., U.S.A., was employed as a control. The control foam had an open-cell content of greater than 90% and various other properties set forth in Table 1 below, under the heading “Example 1.”

For Example 2, a stretch-bond laminate (“SBL”) was formed using two outer layers of VOLTEK® Minicell Foam and an inner elastic meltblown nonwoven web layer formed of KRATON® G1648 (G2760) from Kraton Polymers LLC, which is a styrenic-based elastomeric block copolymer. The elastic meltblown web had a relaxed basis weight of 30 gsm. The elastic meltblown web was stretched to 150% of its initial length and combined with both flexible absorbent foam layers in a nip. The inner surface at each foam layer was coated with 78 gsm of Bostik Findley 2096 meltblown adhesive available from Bostik Findley, Inc. of Wauwatosa, Wis., U.S.A., to facilitate bonding between the layers. The absorbent elastic laminate thus formed was permitted to relax, and exhibited the properties shown in Table 1 below.

For Example 3, a stretch-bonded laminate similar to Example 2 was formed except that the elastic meltblown layer was treated on both sides with particles of superabsorbent material sold as SAM E1 231-99 (bipolar) by BASF located in Charlotte, N.C., U.S.A. The superabsorbent particles were distributed equally on both sides of the SBL between the elastic meltblown layer and the adhesive layer, and constituted about 50.0% by weight of the SBL. The relaxed elastic absorbent laminate exhibited the properties shown in Table 1.

For Example 4, a control example, a flexible thermoplastic absorbent foam layer having an open-cell content of about 80-90% was prepared from the following polymer composition and extrusion settings, and was microapertured to open up the skins on both sides to make it absorbent, flexible, and soft. Further details on how to make the flexible absorbent foam layer are described in U.S. patent application Ser. No. 10/218,825 to Krueger et al., filed 2 Sep. 2005, with respect to Example 2f of the application. The pertinent disclosure is incorporated by reference. Microaperturing is described in U.S. patent application Ser. No. ______, filed on 22 Dec. 2005, entitled “HYBRID ABSORBENT FOAM AND ARTICLES CONTAINING IT,” invented by Baker et al., this application being incorporated by reference. The foam was microapertured ten times on both sides using heated pin apertures.

Base Resin: 53.8% by weight polystyrene sold under the trade name STYRON® 685D by Dow Chemical Co. located in Midland, Mich., U.S.A.

Elastomer: 40.0% by weight KRATON® MD6832 styrene block copolymer, sold by Kraton Polymers LLC located in Belpre, Ohio, U.S.A.

Surfactant: 5.2% by weight CESA-STAT 3301 sold by Clariant Corporation located in Winchester, Va., U.S.A.

Filler: 1.0% by weight talc.

Blowing Agent: Iso-Pentane (8.37 lbs/hr)

Primary Extruder: 120 rpm

This control foam sample exhibited the properties shown in Table 1.

TABLE 1

| | Example | | | | |
|---|---|---|---|---|---|
| | 1 | 2 | 3 | 4 | 5 |
| | Open-Cell Thermoplastic Foam | | | | |
| | Control | Elastic Laminates | | Control | Elastic |
| | | | | | Laminate |
| Test | Voltek | Minicell + | Minicell + | Microapertured | Microapertured |
| | Minicell | Bostik | Bostik Findley | PS- | PS |
| | Foam | Findley 2096 + | 2096 + SAM E1231- | Kraton Foam | Kraton Foam + |
| | | Kraton MB + | 99 + | | Adhesive + Kraton |
| | | Bostik | Kraton MB + SAM | | MB + Adhesive |
| | | Findley 2096 + | E1231-99 + | | Microapertured PS- |
| | | Minicell | Bostik | | Kraton Foam |
| | | | Findley 2096 + | | |
| | | | Minicell | | |
| Basis | 60 | 305 | 586 | 125 | 551 |
| Weight | | | | | |
| (g/m²) | | | | | |
| Dry Bulk | 1.80 | 3.80 | 9.00 | 1.79 | 3.58 |
| (mm) | | | | | |
| Saturated | 8.4 | 3.5 | 12.0 | 3.7 | 1.4 |
| Capacity | | | | | |
| (g/g) | | | | | |
| % Set | 39.3 | 20.6 | 19.1 | Not | 28.7 |
| | | | | Measured | |
| % Load | 91.4 | 87.0 | 85.4 | Not | 42.6 |
| Loss at | | | | Measured | |
| 50% Strain | | | | | |
| Extension | 483.2 | 1192.0 | 1012.0 | 1245.3 | 2140.6 |
| Tension | | | | | |
| (gf per 2- | | | | | |
| inch) at | | | | | |
| 50% Strain | | | | | |
| Retraction | 50.7 | 177.8 | 165.9 | Not | 186.2 |
| Tension | | | | Measured | |
| (gf at 2-inch) | | | | | |
| at | | | | | |
| 50% Strain | | | | | |
| % | 70 | 80 | 85 | Not | 90 |
| Recovery | | | | Measured | |

For Example 5, a SBL was formed using two outer layers of the flexible absorbent foam of Example 4 and an inner elastic meltblown layer formed of KRATON® G1648 (G2760) styrene-based elastic polymer, as used in Example 2. The elastic meltblown web had a relaxed basis weight of 30 gsm. The elastic film was stretched to 150% of its initial length and combined with both flexible absorbent foam layers in a nip. The inner surface of each foam layer was coated with 78 gsm of Bostik Findley 2096 meltblown adhesive, as used in Example 2, to facilitate bonding between the layers. The absorbent elastic laminate thus formed was permitted to relax, and exhibited the properties shown in Table 1.

As shown above, the absorbent elastic laminates of the invention can exhibit an excellent combination of absorbency and elastic properties.

### Test Procedures

### Caliper (Bulk) Test Method

The caliper or thickness of a material, in millimeters, is measured at 0.05 PSI (0.345 KPa) using a Frazier spring model compressometer #326 bulk tester with a 2 inch (50.8 mm) foot (Frazier Precision Instrument Corporation, 925 Sweeney Drive, Hagerstown, Md., U.S.A.). Each type of sample is subjected to three repetitions of testing and the results are averaged to produce a single value.

### Cycle Test Method

The materials were tested using a cyclical testing procedure to determine load loss and percent set. In particular, two-cycle testing was utilized to 100 percent defined elongation. For this test, the sample size was 2 inch (5.08 cm) in the CD by 5 inch (12.70 cm) in the MD. The grip size was 3 inch (7.62 cm) in width. The grip separation was 2 inch (5.08 cm). The samples were loaded so the machine-direction of the sample was in the vertical direction. A preload of approximately 10-15 grams was set. The test pulled the sample at 20 inches/mm (500 mm/mm) to 100 percent elongation (2 inch in addition to the 2 inch gap), and then immediately (without pause) returned to the zero point (the 2 inch separation). The results of the test data arc from the first and second cycles. The testing was done on a Sintech Corp. constant rate of extension tester 2/S with a Renew MTS mongoose box (controller) using TESTWORKS 4.07b software. (Sintech Corp., of Cary, N.C., U.S.A.). The tests were conducted under ambient conditions.

### Saturated Capacity Test Method

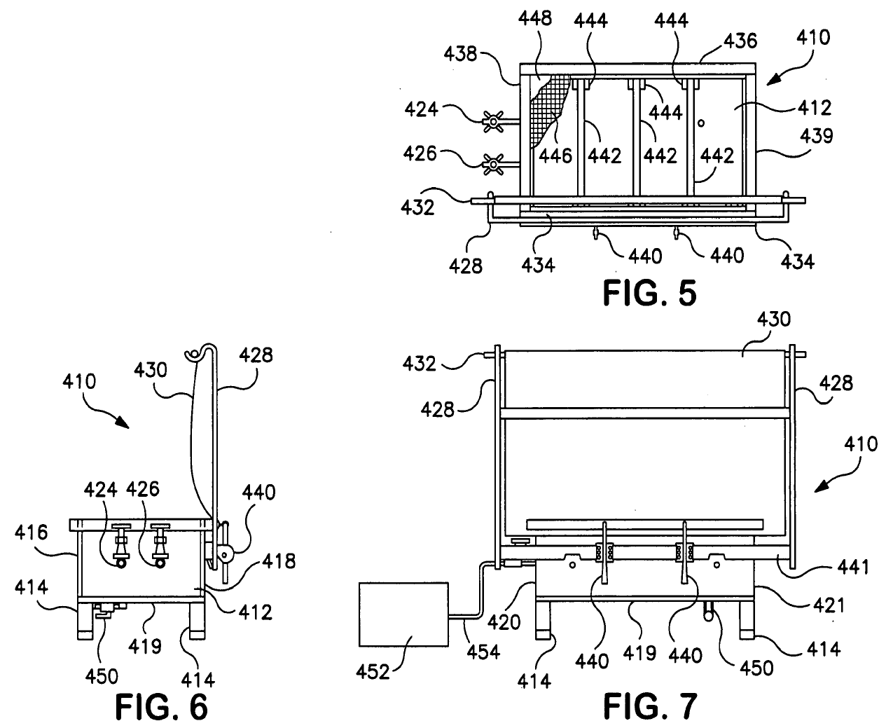

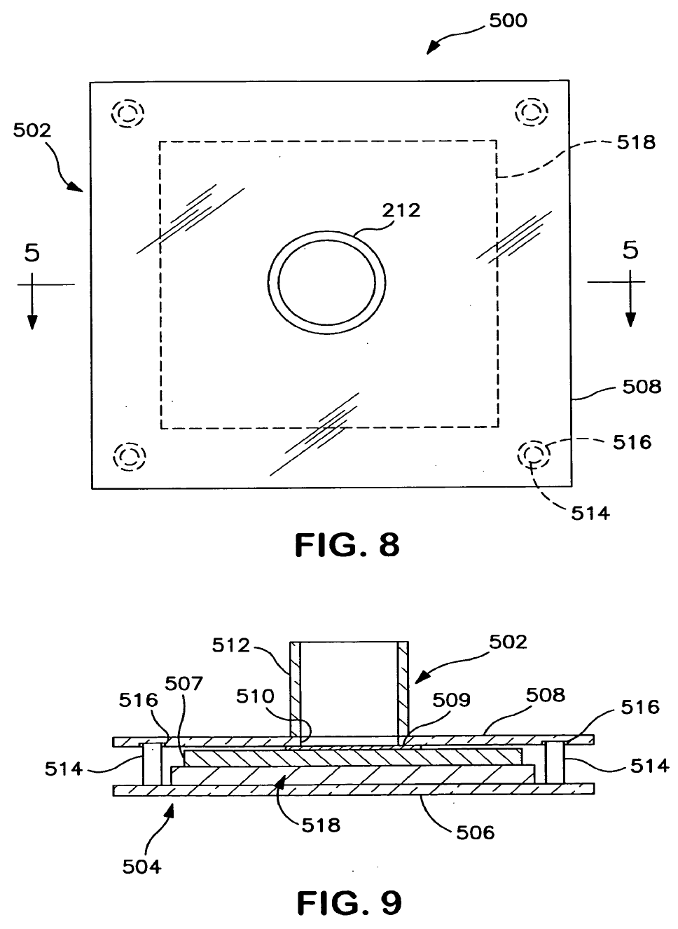

Saturated Capacity is determined using a Saturated Capacity (SAT 20 CAP) tester with a Magnahelic vacuum gauge and a latex dam, comparable to the following description. Referring to FIGS. 5-7, a Saturated Capacity tester vacuum apparatus 410 comprises a vacuum chamber 412 supported on four leg members 414. The vacuum chamber 412 includes a front wall member 416, a rear wall member 418 and two side walls 420 and 421. The wall members are sufficiently thick to withstand the anticipated vacuum pressures, and are constructed and arranged to provide a chamber having outside dimensions measuring 23.5 inches (59.7 cm) in length, 14 inches (35.6 cm) in width and 8 inches (20.3 cm) iii depth.

A vacuum pump (not shown) operably connects with the vacuum chamber 412 through an appropriate vacuum line conduit and a vacuum valve 424. In addition, a suitable air bleed line connects into the vacuum chamber 412 through an air bleed valve 426. A hanger assembly 428 is suitably mounted on the rear wall 418 and is configured with S-curved ends to provide a convenient resting place for supporting a latex dam sheet 430 in a convenient position away from the top of the vacuum apparatus 410. A suitable hanger assembly can be constructed from 0.25 inch (0.64 cm) diameter stainless steel rod. The latex dam sheet 430 is looped around a dowel member 432 to facilitate grasping and to allow a convenient movement and positioning of the latex dam sheet 430. In the illustrated position, the dowel member 432 is shown supported in a hanger assembly 428 to position the latex dam sheet 430 in an open position away from the top of the vacuum chamber 412.

A bottom edge of the latex dam sheet 430 is clamped against a rear edge support member 434 with a suitable securing means, such as toggle clamps 440. The toggle clamps 440 are mounted on the rear wall member 418 with suitable spacers 441 which provide an appropriate orientation and alignment of the toggle clamps 440 for the desired operation. Three support shafts 442 are 0.75 inches (1.90 cm) in diameter and are removably mounted within the vacuum chamber 412 by means of support brackets 444. The support brackets 444 are generally equally spaced along the front wall member 416 and the rear wall member 418 and arranged in cooperating pairs. In addition, the support brackets 444 are constructed and arranged to suitably position the uppermost portions of the support shafts 442 flush with the top of the front, rear and side wall members of the vacuum chamber 412. Thus, the support shafts 442 are positioned substantially parallel with one another and arc generally aligned with the side wall members 420 and 421. In addition to the rear edge support member 434, the vacuum apparatus 410 includes a front support member 436 and two side support members 438 and 439. Each side support member measures about 1 inch (2.54 cm) in width and about 1.25 inches (3.18 cm) in height. The lengths of the support members are constructed to suitably surround the periphery of the open top edges of the vacuum chamber 412, and are positioned to protrude above the top edges of the chamber wall members by a distance of about 0.5 inch (1.27 cm).

A layer of egg crating type material 446 is positioned on top of the support shafts 442 amid the top edges of the wall members of the vacuum chamber 412. The egg crate material extends over a generally rectangular area measuring 23.5 inches (59.7 cm) by 14 inches (35.6 cm), and has a depth measurement of about 0.38 inches (0.97 cm). The individual cells of the egg crating structure measure about 0.5 inch (1.27 cm) square, and the thin sheet material comprising the egg crating is composed of a suitable material, such as polystyrene. For example, the egg crating material can be McMaster Supply Catalog No. 162 4K 14, translucent diffuser panel material. A layer of 6 mm (0.25 inch) mesh TEFLON®-coated screening 448, available from Eagle Supply and Plastics, Inc., in Appleton, Wis., U.S.A., which measures 23.5 inches (59.7 cm) by 14 inches (35.6 cm), is placed on top of the egg crating material 446.

A suitable drain line and a drain valve 450 connect to bottom plate member 419 of the vacuum chamber 412 to provide a convenient mechanism for draining liquids from the vacuum chamber 412. The various wall members and support members of vacuum apparatus 410 may be composed of a suitable noncorroding, moisture-resistant material, such as polycarbonate plastic. The various assembly joints may be affixed by solvent welding, and the finished assembly of the tester is constructed to be watertight. A vacuum gauge 452 operably connects through a conduit into the vacuum chamber 412. A suitable pressure gauge is a Magnahelic differential gauge capable of measuring a vacuum of 0-100 inches of water (0-186 mmNg), such as a No. 2100 gauge available from Dwyer Instrument Incorporated in Michigan City, Ind., U.S.A.

The dry product or other absorbent structure is weighed and then placed in excess 0.9% NaCl saline solution and allowed to soak for twenty minutes. After the twenty minute soak time, the absorbent structure is placed on the egg crate material and mesh TEFLON®-coated screening of the Saturated Capacity tester vacuum apparatus 410. The latex dam sheet 430 is placed over the absorbent structure(s) and the entire egg crate grid so that the latex dam sheet 430 creates a seal when a vacuum is drawn on the vacuum apparatus 410. A vacuum of 0.5 pounds per square inch (psi) (3.45 KPa) is held in the Saturated Capacity tester vacuum apparatus 410 for five minutes. The vacuum creates a pressure on the absorbent structure(s), causing drainage of some liquid. After five minutes at 0.5 psi (3.45 KPa) vacuum, the latex dam sheet 430 is rolled back and the absorbent structure(s) are weighed to generate a wet weight.

The overall capacity of each absorbent structure is determined by subtracting the dry weight of each absorbent from the wet weight of that absorbent, determined at this point in the procedure. The 0.5 psi (3.45 KPa) SAT CAP or SAT CAP of the absorbent structure is determined by the following formula:

SAT CAP=(wet weight−dry weight)/dry weight;

wherein the SAT CAP value has units of grams of fluid/gram absorbent. For both overall capacity and SAT CAP, a minimum of four specimens of each sample should be tested and the results averaged. If the absorbent structure has low integrity or disintegrates during the soak or transfer procedures, the absorbent structure can be wrapped in a containment material such as paper toweling, for example SCOTT® paper towels manufactured by Kimberly-Clark Corporation, Neenah, Wis., U.S.A. The absorbent structure can be tested with the overwrap in place and the capacity of the overwrap can be independently determined and subtracted from the wet weight of the total wrapped absorbent structure to obtain a wet absorbent weight.

### Fluid Intake Flux Test

The Fluid Intake Flux (FIF) Test determines the amount of time required for an absorbent structure, and more particularly a foam sample thereof, to take in (but not necessarily absorb) a known amount of test solution (0.9 weight percent solution of sodium chloride in distilled water at room temperature). A suitable apparatus for performing the FW Test is shown in FIGS. S and 9 and is generally indicated at 500. The test apparatus 500 comprises upper and lower assemblies, generally indicated at 502 and 504 respectively, wherein the lower assembly comprises a generally 7 inch (18 cm) by 7 inch (18 cm) square lower plate 506 constructed of a transparent material such as PLEXIGLAS® for supporting the absorbent foam sample during the test and a generally 4.5 inch (11.4 cm) by 4.5 inch (11.4 cm) square platform 518 centered on the lower plate 506.

The upper assembly 502 comprises a generally square upper plate 508 constructed similar to the lower plate 506 and-having a central opening 510 formed therein. A cylinder (fluid delivery tube) 512 having an inner diameter of about one inch (2.54 cm) is secured to the upper plate 508 at the central opening 510 and extends upward substantially perpendicular to the upper plate. For flux determination, the inside dimension of the fluid delivery tube should maintain a ratio between 1:3 and 1:6 of the sample diameter. The central opening 510 of the upper plate 508 should have a diameter at least equal to the inner diameter of the cylinder 512 where the cylinder 512 is mounted on top of the upper plate 508. However, the diameter of the central opening 510 may instead be sized large enough to receive the outer diameter of the cylinder 512 within the opening so that the cylinder 512 is secured to the upper plate 508 within the central opening 510.

Pin elements 514 are located near the outside corners of the lower plate 506, and corresponding recesses 516 in the upper plate 508 are sized to receive the pin elements 514 to properly align and position the upper assembly 502 on the lower assembly 504 during testing. The weight of the upper assembly 502 (e.g., the upper plate 508 and cylinder 512) is approximately 360 grams to simulate approximately 0.11 pounds/square inch (psi) (0.758 KPa) pressure on the absorbent foam sample during the FIF Test.

To run the FIF Test, an absorbent foam sample 507 being three inches in diameter is weighed and the weight is recorded in grams. The foam sample 507 is then centered on the platform 518 of the lower assembly 504. To prevent unwanted foam expansion into the central opening 510, centered on top of the foam sample 507, is positioned an approximately 1.5 inch diameter (3.8 cm) piece of flexible fiberglass standard 18×16 mesh window insect screening 509, available from Phifer Wire Products, Inc., Tuscaloosa, Ala. The upper assembly 502 is placed over the foam sample 507 in opposed relationship with the lower assembly 504, with the pin elements 514 of the lower plate 506 seated in the recesses 516 formed in the upper plate 508 and the cylinder 512 is generally centered over the foam sample 507. Prior to running the FIF′ Test, the aforementioned Saturated Capacity Test is measured on the foam sample 507. Thirty-three percent (33%) of the saturation capacity is then calculated; e.g., if the test foam has a saturated capacity of 12 g of 0.9% NaCl saline test solution/g of test foam and the three inch diameter foam sample 507 weighs one gram, then 4 grams of 0.9% NaCl saline test solution (referred to herein as a first insult) is poured into the top of the cylinder 512 and allowed to flow down into the absorbent foam sample 507. A stopwatch is started when the first drop of solution contacts the foam sample 507 and is stopped when the liquid ring between the edge of the cylinder 512 and the foam sample 507 disappears. The reading on the stopwatch is recorded to two decimal places and represents the intake time (in seconds) required for the first insult to be taken into the absorbent foam sample 507.

A time period of fifteen minutes is allowed to elapse, after which a second insult equal to the first insult is poured into the top of the cylinder 512 and again the intake time is measured as described above. After fifteen minutes, the procedure is repeated for a third insult. An intake flux (in milliliters/second) for each of the three insults is determined by dividing the amount of solution (e.g., four grams) used for each insult by the intake time measured for the corresponding insult. The intake rate is converted into a fluid intake flux by dividing by the area of the fluid delivery tube, i.e., 0.79 in2 (5.1 cm2).

At least three samples of each absorbent test foam is subjected to the FIF Test and the results are averaged to determine the intake time and intake flux of the absorbent foam.

### Modified Fluid Intake Flux (FIF) Test for Smaller Foam Samples

The test is done in a similar same manner as described in the aforementioned standard Fluid Intake Flux (FIF) Test; however, this test was modified to accommodate smaller samples and yet keep the same fluid delivery tube to sample size ratio as in the standard FIF Test. The modifications included installing the small sample of non-swelling foam that is to be tested into a suitable holder and using a suitable fluid delivery tube. The suitable holder can be an inverted laboratory glass funnel having a uniform diameter cylindrical output tube of one inch long that rests on top of an adjustable lab jack platform positioned for downward gravitational flow. The foam, of sufficient diameter (between 0.18 inch and 0.36 inch, or between 0.46 cm and 0.91 cm) and one inch (2.54 cm) in length, is gently positioned into the top of the uniform diameter glass tube of the inverted funnel that is sufficient in size to hold the foam without significant compression so that one end faces vertically up (proximal end) and the other end is facing downward (distal end). The glass tube holds the foam in a stationary position and is sufficient in length to hold the foam sample yet then immediately enlarges to the funnel opening to avoid discharging flow complications of excess fluid after the fluid leaves the foam's distal end. A fluid delivery tube is constructed with a 0.06 inch (0.15 cm) diameter orifice and a throat length that enlarges to a diameter enabling easy dispensation of fluid into the tube. The enlargement occurs at an approximately 0.25 inch (0.64 cm) length upstream of the orifice. The fluid delivery tube is positioned directly above the proximal end of the foam sample and the inverted funnel and the foam sample is raised using the lab jack such that the fluid delivery tube is brought into contact with the foam. Afterwards, similar to the standard FIF Test, thirty-three percent (33%) of the saturation capacity for the foam sample is then calculated and this volume of 0.9% NaCl saline solution is dispensed using a PIIPETMAN® P-200R1 pipette, available from Gilson, Inc. in Middleton, Wis., U.S.A., or similar pipette, into the fluid delivery tube which measures 0.06 inches (0.15 cm) in discharge orifice diameter, as opposed to a 1-inch (2.54 cm) diameter as described in the standard PIP Test, and the rate of flow is measured with a stopwatch as earlier described. The preference is to utilize the earlier described standard PIP Test rather than the Modified FIF Test and, if discrepancies exist, the standard PIP Test is relied upon.

### Surfactant Permanence Test

The Surfactant Permanence Test is based upon the surface tension 10 depression effect by surfactant addition to water. The surface tension is measured by the duNoüy ring tensiometer method utilizing a Krüss Processor Tensiometer-K 12 instrument, available from Krüss USA in Charlotte, N.C., U.S.A. In general terms, a sample of foam is soaked in distilled water and the surface tension of the supernatant is measured. This surface tension is compared to a calibration curve to determine the amount of surfactant washed from the foam.

Test preparation includes creating a calibration curve for the particular surfactant utilized. This curve shows the reduced surface tension of the solution as surfactant concentration increases. At concentrations above the critical micelle concentration (CMC), the surface tension reduction from additional surfactant is minimal.

A sample of pre-weighed foam is placed in distilled water. The sample is immersed in the room temperature water for 24 hours, allowing fugitive surfactant to leach out of the foam and dissolve into the water. The amount of water used is critical. If the amount of surfactant leached into the water creates a concentration greater than the CMC, measurement of surface tension on the solution will only indicate that the concentration is greater than the CMC. The amount of distilled water used to wash the foam is 100 times the weight of the foam. After the 24-hour soak, the foam is removed from the water/surfactant solution (supernatant). The water in the foam is allowed to drain into the supernatant and gentle pressure is applied to the foam to aid in the removal of excess supernatant in the foam. The surface tension of the total supernatant is then measured. Utilizing the calibration curve, the surface tension corresponds to a weight fraction of surfactant in the water. This weight fraction is then multiplied by the total amount of water to yield the weight of surfactant leached from the foam. The amount of surfactant can be expressed as a fraction of the total surfactant in the initial foam. For example: foam is made with 10 parts surfactant for every 90 parts foam. A 100 gram sample is soaked in 10,000 grams of distilled water. The surface tension measurement of the supernatant indicates that the surfactant concentration in the supernatant is 0.03%. The amount of surfactant dissolved from the foam is 3.0 grams. The amount of surfactant in the initial foam was 10 grams, so 30% of the surfactant was dissolved and 70% of the surfactant remains in the foam.

With Clariant HOSTASTAT® HS-1, the CMC is at a concentration of 0.03%, by weight. At concentrations less than the CMC, the surface tension is described by: σ=5 1n([s])−18 where σ is the surface tension and [s] is the weight fraction of the surfactant. As an example, 2.96 grams of an open-cell polystyrene foam made with 2.5 parts HOSTASTAT® HS-1 to 100 parts polystyrene was immersed in 297.79 grams of distilled water for 24 hours. The surface tension of the supernatant was measured at 39 dynes/cm which corresponds to 0.0027 grams of surfactant dissolved into the water, or 3.7% of the total surfactant; therefore, 96.3% of the surfactant remained in the foam after a 24 hour wash.

The embodiments of the invention described herein are exemplary. Various modifications and improvements can be made without departing from the spirit and scope of the invention. The scope of the invention is indicated by the appended claims, and all changes that fall within the meaning and range of equivalents are intended to be embraced therein.

We claim:

1. An absorbent elastic laminate, comprising:
a liquid permeable bodyside liner;
an absorbent core comprising:
an elastic backing; and
at least a first flexible absorbent open-cell thermoplastic foam layer, wherein the flexible absorbent open-cell thermoplastic foam layer is gathered when the laminate is in a relaxed state; and
a liquid impermeable outer cover, wherein the absorbent core is located between the liquid permeable bodyside liner and the liquid impermeable outer cover.

2. The absorbent elastic laminate of claim 1, wherein the flexible absorbent open-cell foam layer further comprises a superabsorbent material.

3. The absorbent elastic laminate of claim 1, wherein the flexible absorbent foam layer is bonded to the elastic backing.

4. The absorbent elastic laminate of claim 1, wherein the flexible absorbent foam layer has an open-cell content of at least 55%.

5. The absorbent elastic laminate of claim 1, wherein the flexible absorbent foam layer has an open-cell content of at least 65%.

6. The absorbent elastic laminate of claim 1, wherein the flexible absorbent foam layer has an open-cell content of at least 75%.

7. The absorbent elastic laminate of claim 1, wherein the elastic backing comprises a polymer selected from the group consisting of styrene block copolymer elastomers, polyolefin-based elastomers, hydrogenated diene block copolymers, thermoplastic polyether ester elastomers, ionomeric thermoplastic elastomers, polyamide
thermoplastic elastomers, thermoplastic polyurethanes, copolymers thereof, and combinations thereof.

8. The absorbent elastic laminate of claim 1, wherein the laminate has an elastic extensibility of at least about 50% in at least one direction.

9. The absorbent elastic laminate of claim 1, wherein the laminate has an elastic extensibility of at least 100% in at least one direction.

10. The absorbent elastic laminate of claim 1, wherein the flexible absorbent foam layer comprises a thermoplastic foam base resin, a surfactant, and at least one of a plasticizing agent and a thermoplastic elastomer.

11. The absorbent elastic laminate of claim 10, wherein the flexible absorbent foam layer comprises:
about 45 to about 90% by weight of the thermoplastic foam base resin;
about 10 to about 55% by weight of the plasticizing agent; and
about 0.05 to about 10% by weight of the surfactant.

12. The absorbent elastic laminate of claim 10, wherein the thermoplastic foam base resin is selected from the group consisting of polystyrene, styrene copolymers, polyolefins, polyesters, and combinations thereof.

13. The absorbent elastic laminate of claim 12, wherein the plasticizing agent is selected from the group consisting of polyethylene, ethylene vinyl acetate, mineral oil, palm oil, waxes, naphthalene oil, paraffin oil, acetyl tributyl citrate, acetyl triethyl citrate, p-tert-butylphenyl salicylate, butyl stearate, butylphthalyl butyl glycolate, dibutyl sebacate, di-(2-ethylhexyl) phthalate, diethyl phthalate, diisobutyl adipate, diisooctyl phthalate, diphenyl-2-ethylhexyl phosphate, epoxidized soybean oil, ethylphthalyl ethyl glycolate, glycerol monooleate, monoisopropyl citrate, mono-, di, and tristearyl citrate, triacetin (glycerol triacetate), triethyl citrate, 3-(2-xenoyl)-1,2-epoxypropane, and combinations thereof.

14. The absorbent elastic laminate of claim 1, wherein the absorbent foam layer has a fluid intake flux of about 0.15 ml/sec/cm² or greater upon a first insult, about 0.15 ml/sec/cm² or greater upon a second insult, and about 0.15 ml/sec/cm² or greater upon a third insult.

15. The absorbent elastic laminate of claim 1, wherein the elastic backing is stretched in the first direction during bonding of the flexible absorbent foam layer to the elastic backing, and the laminate is elastic in both the first and second directions.

16. The absorbent elastic laminate of claim 1, wherein the flexible absorbent open-cell foam layer is neck stretched in a first direction to cause narrowing in a second direction, and the laminate is elastic in the second direction.

17. The absorbent elastic laminate of claim 3, wherein the elastic backing and flexible absorbent open-cell thermoplastic foam layers are bonded at a plurality of spaced apart locations.

18. The absorbent elastic laminate of claim 3, further comprising one or more additional layers.

19. The absorbent elastic laminate of claim 1, further comprising one or more intervening layers between the elastic backing and the flexible absorbent open-cell thermoplastic foam layers.

20. The absorbent elastic laminate of claim 1, wherein the elastic backing is an interior layer in the absorbent elastic laminate.

21. The absorbent elastic laminate of claim 1, wherein the elastic backing has openings.

22. An absorbent elastic laminate, comprising:
an elastic backing; and
at least a first flexible absorbent open-cell thermoplastic foam layer comprising a thermoplastic foam base resin, a surfactant, and at least one of a plasticizing agent and a thermoplastic elastomer;
wherein the flexible absorbent open-cell thermoplastic foam layer is gathered when the laminate is in a relaxed state.

23. The absorbent elastic laminate of claim 22, wherein the flexible absorbent foam layer is bonded to the elastic backing.

24. The absorbent elastic laminate of claim 22, wherein the flexible absorbent foam layer has an open-cell content of at least 55%.

25. The absorbent elastic laminate of claim 22, wherein the elastic backing comprises a polymer selected from the group consisting of styrene block copolymer elastomers, polyolefin-based elastomers, hydrogenated diene block copolymers, thermoplastic polyether ester elastomers, ionomeric thermoplastic elastomers, polyamide
thermoplastic elastomers, thermoplastic polyurethanes, copolymers thereof, and combinations thereof.

26. The absorbent elastic laminate of claim 22, wherein the laminate has an elastic extensibility of at least about 50% in at least one direction.

27. The absorbent elastic laminate of claim 22, wherein the flexible absorbent foam layer comprises:
about 45 to about 90% by weight of the thermoplastic foam base resin;
about 10 to about 55% by weight of the plasticizing agent; and
about 0.05 to about 10% by weight of the surfactant.

28. The absorbent elastic laminate of claim 22, wherein the thermoplastic foam base resin is selected from the group consisting of polystyrene, styrene copolymers, polyolefins, polyesters, and combinations thereof.

29. The absorbent elastic laminate of claim 22, wherein the plasticizing agent is selected from the group consisting of polyethylene, ethylene vinyl acetate, mineral oil, palm oil, waxes, naphthalene oil, paraffin oil, acetyl tributyl citrate, acetyl triethyl citrate, p-tert-butylphenyl salicylate, butyl stearate, butylphthalyl butyl glycolate, dibutyl sebacate, di-(2-ethylhexyl) phthalate, diethyl phthalate, diisobutyl adipate, diisooctyl phthalate, diphenyl-2-ethylhexyl phosphate, epoxidized soybean oil, ethylphthalyl ethyl glycolate, glycerol monooleate, monoisopropyl citrate, mono-, di, and tristearyl citrate, triacetin (glycerol triacetate), triethyl citrate, 3-(2-xenoyl)-1,2-epoxypropane, and combinations thereof.

30. The absorbent elastic laminate of claim 22, wherein the absorbent foam layer has a fluid intake flux of about 0.15 ml/sec/cm² or greater upon a first insult, about 0.15 ml/sec/cm² or greater upon a second insult, and about 0.15 ml/sec/cm² or greater upon a third insult.
